(19) United States
(12) Patent Application Publication
(10) Pub. No.: US 2002/0032502 A1
(43) Pub. Date: Mar. 14, 2002

(54) Integrated media production security method and system

(76) Inventor: J. Chris Russell, Culver City, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/844,161

(22) Filed: Apr. 27, 2001

Related U.S. Application Data
(60) Provisional application No. 60/202,496, filed on May 5, 2000.

(51) Int. Cl. G06F 17/00

(52) U.S. Cl. 700/214; 700/225; 707/104.1; 707/100

(57) ABSTRACT

In an integrated media production security method and system, a database receives information as media is taken out of and into various production or other stations. Scanners identify specific media and the person moving the media. A data structure associates the handling history with content of the media. The system also controls application of visible and steganographic coding to a recording medium with the media. Data systems control encoding, recording and duplicating processes for media content. The system can manage information supplied to the database. The database provides forensic information regarding the media.

### RELATED APPLICATION

This application claims the benefit of U.S. Provisional Application No. 60/202,496 titled “Media Tracking System” filed on May 5, 2000.

### BACKGROUND OF THE INVENTION

The present invention relates to a method and integrated system for visible and steganographic encoding on recording media and physically tracking media through various production and associating responsible parties with selected handling operations.

While the invention will be of greatest benefit to makers of videocassettes, video compact discs (VCD) or digital video discs (DVD), these forms of media may be protected by the present invention. Sale of professionally pirated content, primarily theatrical films, is a major industry. Various media mentioned are produced in mass quantities and sold between $1 and $30. International distribution channels are well organized and efficient. Distribution is made to flea markets and retail stores alike. The bootleg media industry actively recruits people working in the production phase of the motion picture industry or others who may have access to “screener” tapes. There are a number of instances of bootleg videotapes appearing on the market as early as eight to ten months prior to release.

There are a number of factors contributing to the robust growth of video piracy. It is often easy, at least in comparison to other forms of major theft, to steal videotapes from a content developer or studio. “Screener” tapes must necessarily be circulated among a range of entities prior to reaching market, so that simply keeping a tape locked up prior to its release is not a realistic alternative. Such entities post-protection facilities, external vendors, bid screeners, marketing screeners, and research screeners. Video pirates are further encouraged by the difficulty of tracing the piracy back to its source and the difficulty of pinpointing which specific media piece was copied, at what stage of production and by whom. The piracy system harms creators who are denied royalties and harms society in general since major pirates operate tax free. It is therefore highly desirable to provide a method and system for providing for tracking of media and accountability and for discouraging piracy in the first place.

Security has been improved by steganographic, or hidden, encoding of information onto the media. Watermarking is a prevalent form of steganographic encoding. Watermarking equipment is expensive. It is desirable to provide efficient ways to watermark a large number of media.

### SUMMARY OF THE INVENTION

The present invention provides both for coding media and for physically tracking the media through various stages of production or other handling and for associating responsible individuals with movement of media from one location to another. Each media piece, for example, individual videotapes or discs may be identified with a unique number and a record in a database is established therefore. The next element of the record comprises an identification of the content on the physical media. As the media is moved, for example, from a vault to a cutting room, the system records the scannable indicia on the media and also scans an identity of an agent, usually an individual, moving the media from one place to the other. At the next place it is scanned in and scanners are integrated into the system so that as media moves into and out of one location and to another, a record associated with that particular piece of media is built in the database. Videotapes or other media are also labeled with warning labels. Burn-in warnings and unique identifiers may be encoded into the video, and then removed after production is complete. Steganographic encoding embeds invisible, unique identifiers into the audio and video. Preferably, vendors and other critical participants in the production process are outfitted for the inclusion in the tracking and identification system to further maintain records on movement and processing of the media.

The invention operates to minimize security exposure by providing a self-enforcing mandatory medium handling record keeping procedure. The database record provides an analysis of what happened to a piece of media that has been pirated, when and by whom to provide a source for forensic analysis in pursuing pirates. Also, a video router is used to rotate the steganographic embedding encoder among individual video decks in a round-robin fashion. Casual copying by less sophisticated pirates is discouraged. Sophisticated pirates face much greater difficulty in trying to steal a tape. Recruitment of accomplices is made more difficult since traceability is greatly increased.

### BRIEF DESCRIPTION OF THE DRAWINGS

The means by which the forgoing features of the invention are implemented are pointed out with particularity in the claims forming the concluding portion of the specification. The invention, both as to its organization and manner of operation, may be further understood by reference to the following drawings taken in connection with the following description.

Of the drawings:

FIG. 1 is a block diagrammatic representation of a system comprising the system of the present invention;

FIG. 2 is a chart illustrating movement of media from one physical location to another and the tracking thereof;

FIGS. 3a and 3b charts are illustrating a particular piece of media and data records associated therewith to be stored in the database;

FIG. 4 is a block diagram illustrating the process of and hardware for recording produced audiovisual information onto the media and of duplicating the recorded original respectively;

FIG. 5 is a block diagrammatic representation of an audiovisual system for encoding the media;

FIG. 6 is a block diagrammatic representation of a marking system shown in greater detail;

FIG. 7 is a timing chart illustrating timing of the encoding so that steganographic encoding is aperiodic on a recoding medium.

### DETAILED DESCRIPTION OF THE INVENTION

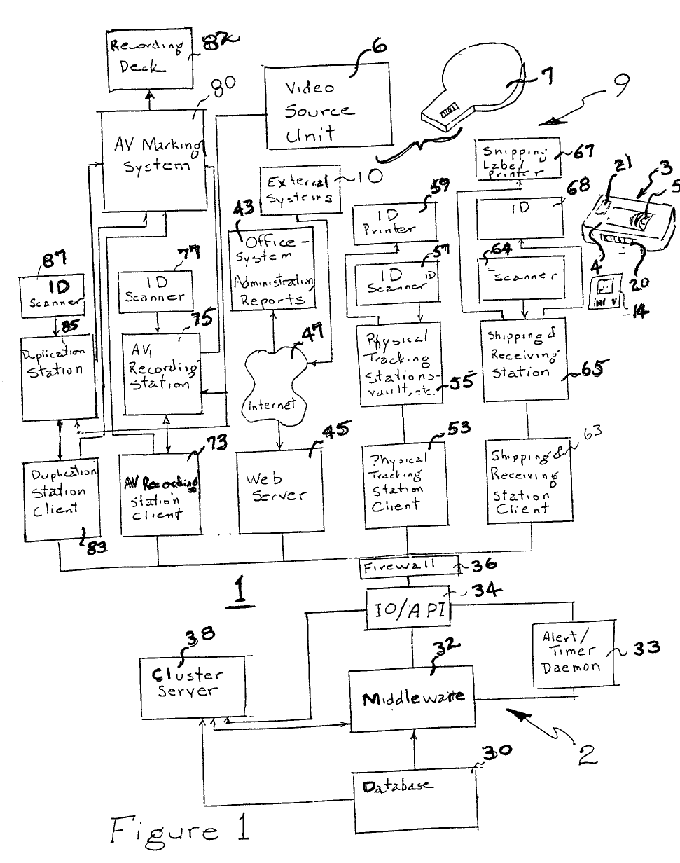

FIG. 1 is a block diagrammatic variation of system comprising the present invention and performing the method of the present invention. The system 1 comprises a data system 2. The data system 2 comprises means for storing, receiving and communicating information regarding a plurality of media 3. For purposes of the present description, a single product piece containing a recording is referred to as media 3. In FIG. 1, the media 3 comprises a recording medium 5 in the form of a videotape in a container 4 which is a plastic box. However, the media 3 is representative of other forms. For example, were the media 3 a video compact disc, the recording medium 5 would be recordable tracks, and container 4 would comprise a plastic disc in which the recording medium 5 was embedded. Container 4 here means a container for the recording medium and not for the media 3.

A video source unit 6, which may comprise a computer hard drive 7 interact to provide audio visual input to a media processing system 9. The video source 6 unit in many applications will comprise an original production machine such as an AVID video editor or a TELECINE apparatus. In this form of the invention, a hard drive 7 containing the original audio video material from which media 3 will be transcribed, will also be protected by the present system.

The media processing system 9 comprises means for tracking physical movement of media 3, physical processing of the media 3. The majority of the processing system 9 will usually be located at one site, e.g. a production facility. External systems 10 may include contractor production facilities or promotional screening rooms. The processing system 9 also includes means for administration for the system 1 and for capturing information, translating information and communicating with the data system 2. The media processing system 9 of the present invention will utilize unique marking of all physical media 3. For example media 3 may be marked with identification tags 20 (FIG. 1), which in current technology will most conveniently comprise barcode labels. Many other forms of suitable labels are known. Warning labels 21 carrying text or other indicia may also be affixed to the container 4. Additionally, each recording medium 5 is marked both with burn-in warnings and unique identifiers in the video content as with steganographic invisible identifiers in both audio and video tracks.

While some industries, such as pharmaceuticals, have a tradition of maintaining records of product flow and operations on each product, many industries do not. The entertainment industry uses new, high technology equipment within old-fashioned protocols, or more likely lack of protocols. The use of the system of the present invention creates a self-enforcing protocol requiring accountability and procedures for handling of media 3. The lack of accountability, which has been conducive to piracy is eliminated. Further, the industries need not hire a raft of quality control personnel. Rather the formal protocol embodied in the system 9 and the data system 2 enables audits to account for all media 3.

The production system may be implemented in phases so that successive levels of security, as further described below may be integrated into the system 1. This may be a definite advantage for a production company that cannot implement the entire system at once.

It should be noted that the description of FIG. 1 refers to a number of separate clients, each of which may comprise, for example, a personal computer, Apple computer or SPARC station. However, it is well-known in that art processing may be further distributed among other components. Similarly processing may also be concentrated in particular, larger processors which replace a plurality of clients or servers. Therefore the description of certain data paths and certain processing interactions need not be accomplished by the specific hardware shown. In accordance with principles well-known in the art, the descriptions also apply to other forms of functionality to provide the interaction taught by the specification.

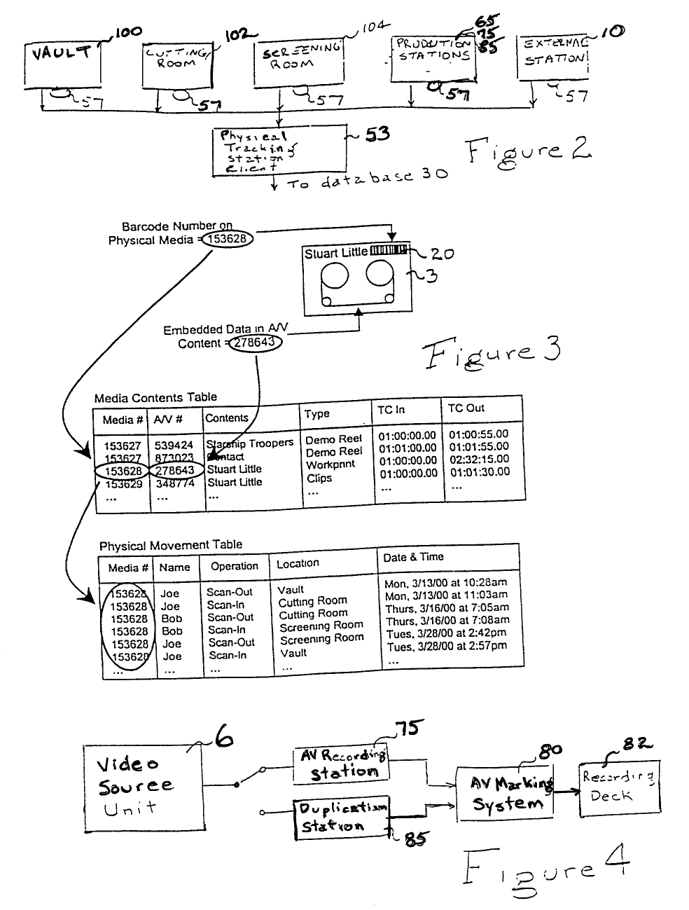

A database 30 receives records created in accordance with the present invention including the identity of specific media 3, entities accountable for the media 3 at a particular processing stage and the identity of the processing stage. As further explained with respect to FIG. 3 below, this information correlated with respect to the content of the particular media 3. The database 30 is accessed by middleware 32. For best reliability and security no other software directly accesses the database 30. However, system administration tools may need to access the database 30's “internal” accounts. A particularly suitable example of a database 30 is the Oracle 8i database. The middleware 32 may be interfaced to the outside world by an input/output unit 34 provided between the middleware 32 and a firewall 36. An alert/timer daemon 33 is coupled between the middleware 32 and the I/O 34. The alert/timer daemon 33 is used for triggering alarms and for e-mailing warnings and alerts. It is also programmed to detect, report, and in some instances correct data inconsistencies. The alert/timer daemon may also determine timing and trigger movement of records within the database 30 to an archives section included in the database 30. Further, the alert/timer daemon 33 is responsible for periodically synchronizing data from a database which may be included in the database 30 of identities of employees or other agents handling the media 3.

The input/output interface 34 may conveniently comprise an input/output application program interface (I/OAPI). A firewall 36 is provided to prevent unauthorized communications between the database 30 and outside world. A cluster server 38 is provided coupled to the input/output unit 34, middleware 32 and the database 30 in some forms of the invention to control contingency plans and provide for redundant operations if a hardware or software failure occurs. Veritas High Availability software is an example of a suitable program for performing this function.

Outside the firewall 36 there are connections to local functions, local meaning within the production facility, remote functions and an Internet interface, with access to the rest of the world and to some degree beyond. The systems administration and production of reports may be done via an office 43 remote from a production facility or other location of the database system 2. The office 43 may comprise a computer communicating via Internet 47 to a web server 45 intermediate the Internet 47 and the firewall 36. The office 43 may include its own system administration tools and may also interact with systems administration tools resident in the middleware 32. External systems 10 may also communicate via the Internet 47 to web server 45. The external systems 10 may include physical tracking stations 54 as further described immediately below.

A physical tracking station client 43 receives inputs from and supplies inputs to a physical tracking station 55. The physical tracking station includes an ID scanner 57 and may further include an ID printer 59. Functioning of the ID scanner is further described with respect to FIG. 2. The ID scanner 57 scans physical media 3 and also scans an identification 14 of a person or other agency moving the physical media 3 into or out of a particular station. A commonly used form of employee identification 14 is a badge having a number magnetically coded therein, in which case the identity scanner 58 will comprise a magnetic card reader. Other forms of identification include bar coded badges or badges including radio frequency identification (RFID) tags. A fingerprint or voice identification may also be used. The system designer only need optimize cost constraints against desired levels of security.

A physical tracking station is included at each station at which the media 3 is handled. The physical tracking station 55 includes processing circuitry for interpreting outputs of identification scanners 57, and may further include known analog to digital conversion circuitry for communicating with the physical tracking station client 53. Other ID scanners 57 at different work stations further described below are separately named and numbered. They are the same as the ID scanner 57 and therefore are referred to in this paragraph interchangeably with the ID scanner 57. They may be coupled to the physical tracking station 55 or may communicate via clients at the respective locations to the physical tracking station client 53 which will provide location information for the media 3 to the database 30.

A shipping and receiving station client 63 communicates with a shipping and receiving station 65. The shipping and receiving station 65 may operate a shipping label printer 69 and a shipping ID tag maker 68. While the ID tag usually produced by the ID tag maker 68 will most conveniently comprise a bar code label, radio frequency identification (RFID) tags or other forms of tags may also be produced. An identification scanner 67 at the shipping and receiving station 65 may feed location and identity information via the shipping and receiving station client 63. The shipping and receiving station client 63 may import shipping address list or they may import software for modification to the type of Id tag produced. The shipping and receiving station 65 can ship out media, receive media and document proper disposal of large or small numbers media 3.

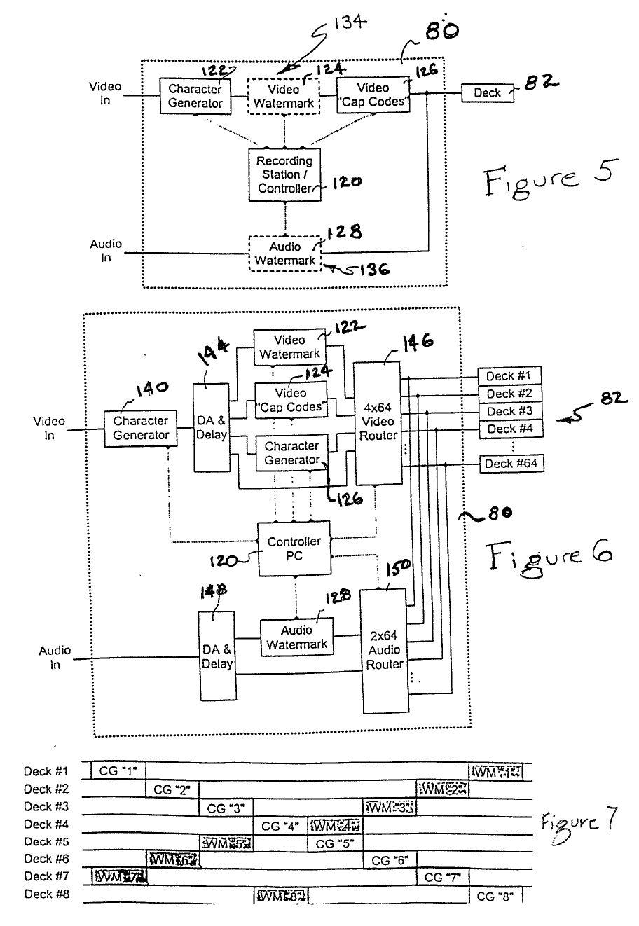

A recording station 75 is provided which communicates via a recording client 73 to the database section 2, the office 43. ID scanner 77 may be coupled to the recording station 75. Recording station 75 is used primarily for record operations, such as recording output from a video source unit 6 to record onto recording medium 5 such as a video tape, CD or DVD. The recording station 75 comprises a marking to burn in warnings, e.g. “property of studio”, time codes, and ID code for the particular recording medium 5 and other information such as the name of the recipient, if known. Unique, visible cap codes are embedded into the video track. Further, unique invisible AV watermarks are embedded in the content on the recording medium 5 by an AV marking system 80. The recording station 75 preferably uses the AV recording station client 73 as a scanner client PC and uses AV controller computer 120 (FIG. 5) to AV control recording station 75 and AV marking system 80 performance. Client software in the AV recording station client 73 preferably includes client software details of the AV marking system 80 and the AV recording station 75.

A duplication station 85 communicates with duplication station client 83. The duplication station client may provide information to the database 30 from an ID scanner 87. Duplication station 85 is used for duplication operations, to produce mass copies of media 3. Also, it may be used simply for location tracking of media, disposal or record operations. Preferably the duplication station 85 receives an input from the video source unit 6. The duplication station 85 receives a video input which is processed by the AV marking system 80 and recorded by a recording deck 82 including one or more individual decks 81 (FIG. 6).

FIG. 2 is a block diagrammatic representation of physical media tracking within the present invention. Media 3 is tracked as it is handled for various operations. For the present description, media 3 is taken to have its initial location in a vault 100. The case of the media 3 being an unedited original tape is considered. It may be necessary to move the tape to a cutting room 102 and back to vault 100. An edited tape may be sent to a screening room 104 additionally, media 3 needs to go through recording station 75 for marking of AV codes thereon. When ready for distribution, the media 3 is provided to the duplication station 85. External locations 10 of various forms may be needed to process the media 3. Vendors and other critical participants in the production process are thus included in the system of the present invention. Different locations to which the media 3 may be taken includes an ID scanner 57. When media 3 enters a location, the ID scanner 57 identifies the media 3. Additionally, the ID scanner 57 scans the badge 14 to identify the employee. The physical tracking station 55 produces a signal indicative of the identity of the location, the particular media 3 and if the media is being moved in or out of the location. Additionally, the employee is identified by reading the identification 14.

Examples of records produced are illustrated in FIG. 3a and FIG. 3b and are respectively a media contents table and a physical movement table. As further described below with respect to FIG. 6 and 7, when AV content is recorded onto media 3 whether by individual recording or by duplication, content is uniquely marked with a tracking number burned into the recording medium 5 using a character generator (FIGS. 5 and 6). At least one particular identifier is embedded in the recording medium 5. Additionally, the indicia 21 on the media 3 identifies the particular physical media 3 in which the particular content is embodied. FIG. 3 is illustrative of the software capturing output video scanners in that it illustrates the record provided to the database 30. For example, in FIG. 3a a media contents table may in the first column comprise identification data embodied in the indicia 21. A second column comprises identity of AV content in the recording medium 5. A third column is a title associated with the contents identification, while a fourth column identifies what the media comprises. For example, the media 3 could be a demo reel for a work print or a collection of clips. The identification in the fourth column not only differentiates one type of content from another, it can also indicate the current state of content. For example, a work print may be edited to become a final print. A final print may be erased to become a blank tape. Update information may be provided to the physical tracking station client or from recording or duplication stations 75 or 85 or by other means.

In the present embodiment, the table in FIG. 3a is associated with the table in FIG. 3b, being linked by the media identification as embodied. For example, in the first column the media number is listed. In the second column, the information corresponding to the identity scanned by the scanner 58. This information may comprise the decoded indicia from a badge 14 or may comprise a name corresponding to the decoded indicia. In the third and fourth columns, the operation, namely taking in or taking out, is listed and the location of the operation is also listed. A fifth column is provided for listing date and time. The ID scanner 57 and physical tracking station 55 provides signals for interpretation by the physical tracking station client 53, or timestamps may be provided by/form internal clocks of the physical tracking station 53. If media 3 is stolen from a production facility, the identity of the last person to handle it is recorded.

FIG. 4 is a block diagram illustrating integration of the video source 6 with the recording station 75 and duplication station 85. In FIG. 4 the recording process is illustrated the input videos provided from both “basic” information from the video source unit 6. The video source unit 6 provides information to be recorded selectively to the recording station 75 or the duplication station 85. Identity of information to be recorded including what sorts of indicia and identification embodied in the recording medium 5 may be entered by the recording station client 73 or the duplication station client. The identity of the destination tape deck 82 (FIG. 1) is provided to the database 30. Data may also be provided to the recording station controller (FIG. 5) to provide for configuration of AV routers. The video input source 6 may comprise an Avid or Telecine editor. Duplication operation is further illustrated in FIG. 4 where a completed media 3 is produced at the recorder deck 82. Again, basic information to be reproduced in addition to content may be entered, for example, via the duplication station client 83. The recording deck 82 may comprise 64 separate decks (FIG. 6). The identification of the coding to be added by AV marking system 80 may be entered through the duplication station client 83. If, for example, other marking is already included on the recording medium 5, it is not necessary to reproduce the watermarking mainly reproduction operation. If, however, the duplication station 85 is receiving its input from the video source unit 6, the full range of indicia entry by the AV marking system 80 may be utilized. A single AV marking system is thus used to fulfill steganograph recording requirements of the present security system and may be used to encode many media at once.

FIG. 5 is a basic block diagrammatic representation of the AV marking system 80. Input terminals “video in” and “audio in” receive content of input. These terminals may represent an input from the duplication station 85, the recording station 75 or an input coupled from the video source unit 6. A recording station controller 120 is provided which programs a character generator 122, a video watermarking circuit 124 and a video capcoder 126. These components are connected in series between the video in terminal and the recording deck 82. Their relative positions may be varied. The recording station controller 120 so controls an audio watermark devise 128 connected between the audio in and the deck 82. The recording station controller may comprise a separate computer or may be included AV recording station client 73, the duplication station client 83 or other computer. In summary, the character generator 122, video watermark device 124, and video capcoder 126 together comprise video coding means 134. The video coding means may include the particular encoders shown or may include other encoding means. Similarly, the audio watermark circuit 128 comprises audio encoding means 136 which comprises well-known audio marking means. While an audio watermark is a preferred steganographic form of marking, other encoding schemes may be used.

FIG. 6 is a more detailed description of the AV marking system 80. The recording station controller 120 provides information to a character generator 140 connected between the video in terminal and a digital to analog converter (D/A) and delay line 144. Of course, the embodiment assumes production of a video, since CDs and DVD signals would already be in digital form. The D/A delay line 144 supplies information to four channels, mainly the video watermark encoder 122, the video capcoder 124 and character generator 126 as well as a direct connection all of which provide outputs to a 4×64 video router 146. In the present illustration, a simplified 4×64 is shown which supports a single input to 64 decks. Thus four channels of information may be provided to each of the 64 decks in the recording deck 82. Other known routers may be used to support multiple video inputs to all the decks or to any combination these as controlled by recording station controller 120. A plurality of video sources 7 may be duplicated at one time, and the decks in a recording deck 82 may be partitioned, so that each individual deck in a partition is recorded from a selection of one or more video sources 7. Similarly, the D/A delay line 144 provides digital outputs to an audio watermark encoder 128 and also a direct output to a 2×64 audio router 150. The audio watermark encoder also provides the output to the 2×64 audio router 150. Two audio channels are thus provided for each of the 64 decks within the recording deck 82. The recorder station controller 120 also controls timing of the application of encoding from the routers 146 and 150 to the selected ones of the 64 decks.

FIG. 7 is a simplified timing diagram of application of character generator (CG) encoding and watermark (WM) encodings which are the video content. FIG. 7 illustrates that the recording station controller 120 is programmed to apply the CG and WM encoding in differing sequences. Also, the WM coding is not applied media in successive tracks in the deck 82 in sequence. FIG. 7 is only exemplary, and many temporal distributions may be used. With rotation of character generator and video watermarking hardware, a pirate cannot calculate where on recorded medium 5 where the encoded matter will be.

The above system performs a method of tracking movement of media, associating movement from one station to another with a particular individual and producing a record of the movement and operation performed on the media. Further, the tracking of movement is integrated with the application of coding indicia on the medium. Further, the tracking of movements and operations on the media at remote locations is integrated with tracking of its movement within a production facility. Operations performed on the media include recording duplicating and application of encoding.

The present specification will enable those skilled in the art to produce many equivalent forms of the present invention any departures from the particular embodiment described herein, such as those suggested in the specification, may be made to provide a method and system in accordance the present invention.

What is claimed is:

1. An integrated media production security system comprising:
a database for storing records associated with a plurality of discreet media;
tracking stations for reading indicia on media for responding to arrival at and departure from the tracking station, said tracking station further comprising means for identifying an agent moving the media to or from the tracking station; and
a client for receiving information from said tracking station for providing records to said database.

2. The system according to claim 1 wherein said database further comprises means for storing content information records associated with each discrete piece of media and wherein said database is provided with a software structure associating content records and movement records by media identification.

3. The system of claim 2 further comprising a system administration client coupled for communicating with said database.

4. The system according to claim 3 comprising a tracking station at a media vault.

5. The system according to claim 4 wherein further stations at which the media is tracked comprising a recording station, a duplication station and a shipping and receiving station.

6. The system according to claim 5 further comprising a video source unit selectively coupled to said duplication station and to said recording station and also further comprising an AV marking system and a recording deck to receive outputs from said AV marking system and said duplication and said recording station each providing a video source for said AV marking system.

7. A system according to claim 6 wherein said client further provides means for providing data indicative of operations performed on selected media to said database.

8. A system according to claim 7 wherein said video source unit comprises a hard drive, and wherein indicia for reading by a tracking station are affixed to said hard drive, wherein said tracking means further comprises means for reading indicia for said hard drive and wherein said database further comprises a data structure for storing information relative to said hard drive.

9. An integrated media production security system comprising data means, communication means and production means, said production means handling discreet media, said data means comprising a database having data structures for storing records associated with discreet media input-output/application program interface means interfacing the database means to the communication means, said communication means comprising at least one client for receiving information associated with operations on the media and communicating with said database, and said production unit comprising means for tracking movement of media to or from stations said tracking means further comprising means for identifying the agency causing the movement of the media and further comprising station for performing operations on media, said client means receiving information indicative of said operation and providing records to said database indicative thereof.

10. The system according to claim 9 wherein said stations each comprise scanning stations and also comprise client means.

11. The system according to claim 10 wherein said client comprises a system administration station for communicating with said database.

12. The system according to claim 11 wherein said communication system further comprises links to external systems and wherein the external systems are provided with tracking stations and client means providing information indicative of operations at each respective external system

13. A method for an integrated media production security system comprising the steps of:
tracking movement of discreet media to and from tracking stations;
tracking an agent associated with each movement;
providing a data record indicative of the movement and agent to a database;
providing to said database a record indicative of content associated with a discreet media identification;
associating in said database records indicative of movement with a record indicative of content of the particular discreet media;
further providing data indicative of an operation performed on said discreet media at a station associated with the record of movement of the discreet media.

14. The method of claim 13 wherein a recording and a duplication station are provided and further comprising:
selectively duplicating video source on media at said duplication station or recording from a video source onto a recording media at a recording station and
connecting an AV marking station to each of said recording stations and duplication station to steganographically encode the recording or duplication of said video source.

15. A system to steganographically encode media comprising:
a video source unit for providing video to be recorded or duplicated;
a recording deck for recording audio visual information in media;
an audio visual (AV) marking system for encoding signals provided by said audio source;
at least one station for coupling the signals provided by said video source unit for encoding by said AV marking system; and
a station controller for controlling operations flow of the signals and operations on the media.

16. The system of claim 15 wherein said at least one station comprises a recording station and a duplicating station.

17. The system of claim 16 wherein said each AV marking system comprises a watermarking system, and wherein said controller couples said AV marking means to record aperiodically on each said media.

18. A method for steganographically encoding media comprising:
providing signals from a video source unit;
coupling the signals to at least one station;
connecting at said station the signals to an audio visual marking unit for encoding; and
controlling the application of steganographic coding on the media.

19. The method of claim 18 wherein said at least one station comprises a recording station and a duplicating station, and further comprising the step of selectively providing the signals to one of these stations.
